(19) United States
(12) Patent Application Publication
(10) Pub. No.: US 2015/0040346 A1
(43) Pub. Date: Feb. 12, 2015

(54) Caster Wheel Structure

(71) Applicant: Po-Chuan Tsai, Tainan City (TW)

(72) Inventor: Po-Chuan Tsai, Tainan City (TW)

(21) Appl. No.: 13/961,925

(22) Filed: Aug. 8, 2013

(51) Int. Cl. B60B 33/00

(52) U.S. Cl. CPC B60B 33/0028
USPC 16/45

(57) ABSTRACT

A caster wheel structure contains a body and a connecting shaft. The connecting shaft includes an engaging tab arranged around a bottom end thereof, and the engaging tab has an abutting rim arranged around an upper end thereof The body is injection molded and coupled with a holder by using the connecting shaft. The body includes a hole defined therein so as to insert the connecting shaft, and the hole has a receiving chamber formed therein and communicating with the hole. The connecting shaft is inserted into the hole of the body so that the engaging tab of the connecting shaft is mounted in the receiving chamber of the body. Thereby, when the connecting shaft is coupled with the body, the abutting rim of the engaging tab contacts with a bottom periphery of the hole, such that the connecting shaft is fixed by the bottom periphery of the hole securely.

### FIELD OF THE INVENTION

The present invention relates to a caster wheel structure in which a connecting shaft is coupled with a body securely.

### BACKGROUND OF THE INVENTION

As shown in FIG. 1, a conventional caster wheel structure contains a body 1 and is injection molded. The body 1 includes a central groove 10 defined therein, and the central groove 10 has a peripheral flange 101 arranged around a lower side thereof so that a connecting shaft 2 is inserted into the central groove 10 of the body 1, wherein the peripheral flange 101 of the central groove 10 is retained in a notch 20 of the connecting shaft 2, hence the connecting shaft 2 is coupled with the body 1. However, the peripheral flange 101 of the central groove 10 disengages from the notch 20 of the connecting shaft 2 after a long period of using time, thus the connecting shaft 2 removes from the body 1 easily.

The present invention has arisen to mitigate and/or obviate the afore-described disadvantages.

### SUMMARY OF THE INVENTION

The primary object of the present invention is to provide a caster wheel structure in which when a connecting shaft is coupled with a body, an abutting rim of an engaging tab of a connecting shaft contacts with a bottom periphery of a hole of the body, such that the connecting shaft is fixed by the bottom periphery of the hole securely.

To obtain the above objectives, a caster wheel structure contains: a body and a connecting shaft.

The connecting shaft includes an engaging tab defined on a bottom end thereof, and the engaging tab has an abutting rim arranged around an upper end thereof. The body is injection molded and is coupled with a holder by ways of the connecting shaft. The body includes a hole defined therein so as to insert the connecting shaft, and the hole has a receiving chamber formed therein and communicating with the hole. The connecting shaft is inserted into the hole of the body so that the engaging tab of the connecting shaft is mounted in the receiving chamber of the body.

Thereby, when the connecting shaft is coupled with the body, the abutting rim of the engaging tab of the connecting shaft contacts with a bottom periphery of the hole of the body, such that the connecting shaft is fixed by the bottom periphery of the hole securely.

### BRIEF DESCRIPTION OF THE DRAWINGS

FIG. 1 is a cross sectional view of a conventional caster wheel structure.

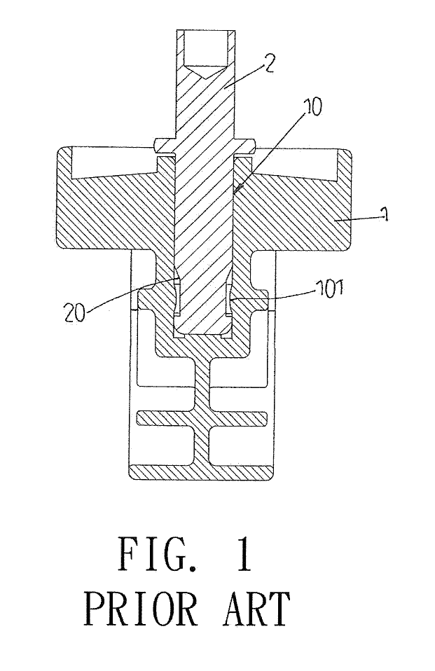

FIG. 2 is a perspective view showing the assembly of a caster wheel structure according to a preferred embodiment of the present invention.

FIG. 3 is a perspective view showing the exploded components of the caster wheel structure according to the preferred embodiment of the present invention.

FIG. 4 is a cross sectional view showing the assembly of the caster wheel structure according to the preferred embodiment of the present invention.

FIG. 5 is a perspective view showing the operation of the caster wheel structure according to the preferred embodiment of the present invention.

### DETAILED DESCRIPTION OF THE PREFERRED EMBODIMENTS

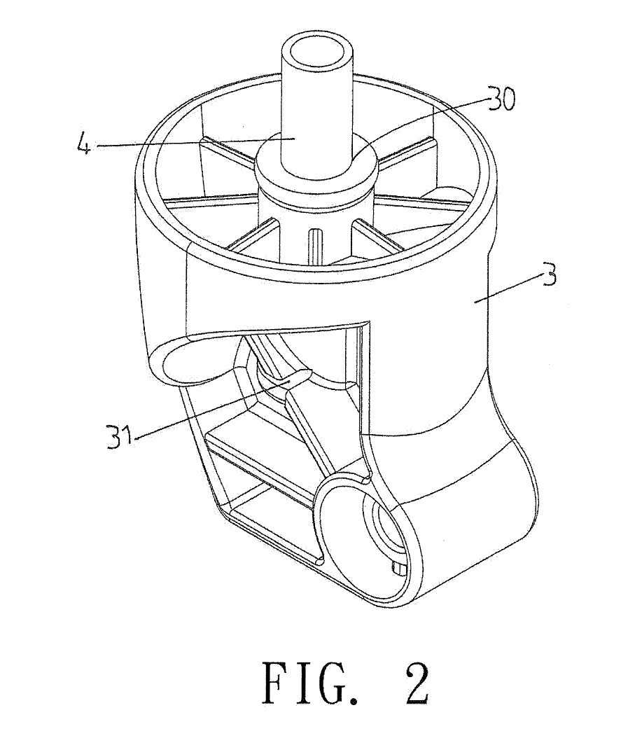

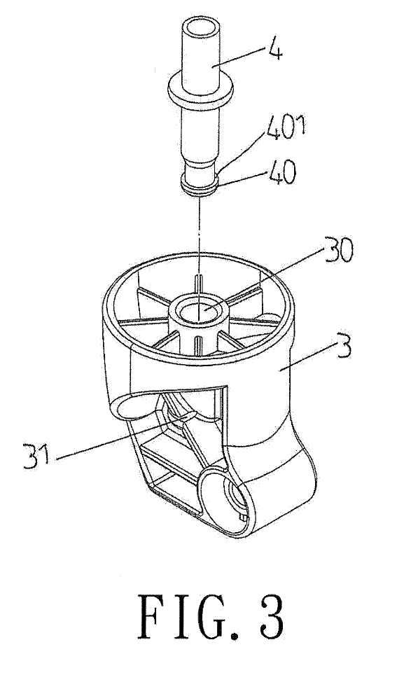

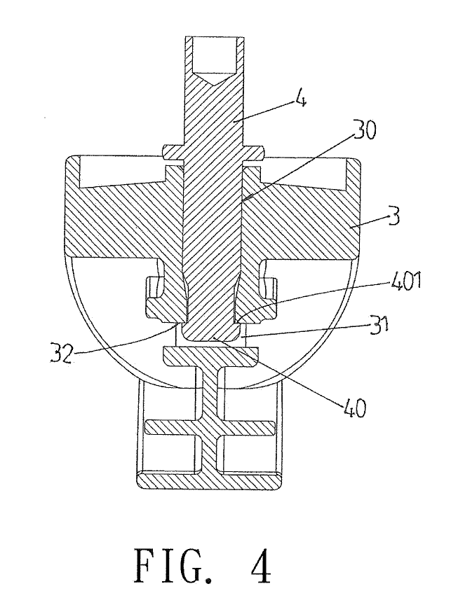

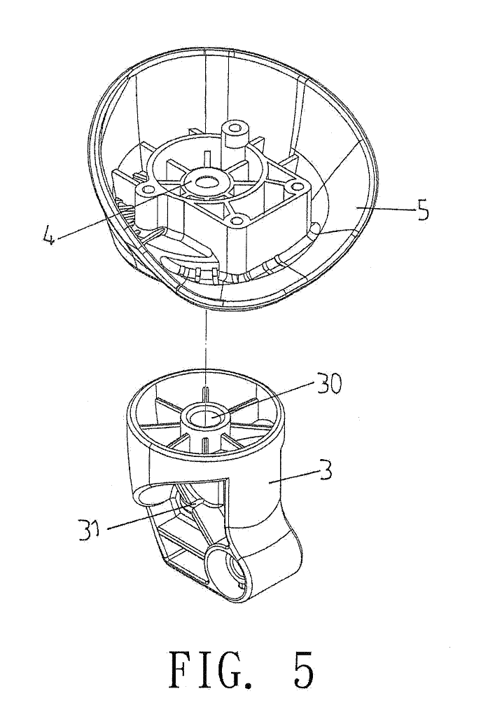

With reference to FIGS. 2-5, a caster wheel structure according to a preferred embodiment of the present invention comprises: a body 3 and a connecting shaft 4, wherein the connecting shaft 4 includes an engaging tab 40 arranged around a bottom end thereof, and the engaging tab 40 has an abutting rim 401 formed around an upper end thereof; the body 3 is injection molded and is coupled with a holder 5 by ways of the connecting shaft 4, and the body 3 includes a hole 30 defined therein so as to insert the connecting shaft 4, wherein the hole 30 has a receiving chamber 31 formed on a bottom end thereof and communicating with the hole 30; the connecting shaft 4 is inserted into the hole 30 of the body 3 so that the engaging tab 40 of the connecting shaft 4 of the connecting shaft 4 is mounted in the receiving chamber 31 of the body 3, and the abutting rim 401 of the engaging tab 40 of the connecting shaft 4 contacts with a bottom periphery 32 of the hole 30 of the body 3, such that the connecting shaft 4 is fixed by the bottom periphery 32 of the hole 30 securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A caster wheel structure comprising:
a body and a connecting shaft, wherein the connecting shaft includes an engaging tab arranged around a bottom end thereof, and the engaging tab has an abutting rim formed around an upper end thereof;
the body is injection molded and is coupled with a holder by ways of the connecting shaft, characterized in that:
the body includes a hole defined therein so as to insert the connecting shaft, the hole has a receiving chamber formed on a bottom end thereof and communicating with the hole;
when the connecting shaft is inserted into the hole of the body the engaging tab of the connecting shaft is mounted in the receiving chamber of the body, and the abutting rim of the engaging tab of the connecting shaft contacts with a bottom end of the hole of the body, such that the connecting shaft is fixed by the bottom end of the hole securely.

2. (canceled)
